(19) United States
(12) Patent Application Publication
(10) Pub. No.: US 2015/0178810 A1
(43) Pub. Date: Jun. 25, 2015

(54) FUEL PRICE DATA DISPLAY

(71) Applicant: Kalibrate Technologies PLC, Manchester (GB)

(72) Inventor: Adrian Preston, Manchester (GB)

(21) Appl. No.: 14/138,998

(22) Filed: Dec. 23, 2013

(51) Int. Cl. G06Q 30/06; G06Q 50/06

(52) U.S. Cl. CPC G06Q 30/0629; G06Q 50/06

(57) ABSTRACT

A method of displaying fuel price data comprising receiving a plurality of fuel price data display components, each fuel price data display component being configured to display fuel price data and receiving a search interface configured to receive input data indicating a search criterion associated with fuel price data. Data indicating a link between the search interface and one or more of the plurality of fuel price data display components is received and the fuel price data is displayed, wherein said fuel price data is displayed in the one or more fuel price data display components linked to the search component based upon the search criterion.

### TECHNICAL FIELD

The present invention relates to display of fuel price data to a user.

### BACKGROUND OF THE INVENTION

In many industries, commercial organisations have to determine prices at which their products are to be sold. Determination of such prices will need to take into account various factors. For example, a particular commercial organisation may wish to ensure that its prices are within a predetermined limit of a particular competitor's prices. Similarly, a commercial organisation may wish to ensure that a particular constraint is applied such that prices of different products sold by that organisation have a predetermined relationship with one another.

A particular industry in which prices need to be determined is the fuel industry. In particular, it is necessary to determine prices at which fuel is to be sold at retail fuel sites. The price charged by a particular retail fuel site will be determined by a number of different parameters. For example, prices charged by the retail fuel site's competitors are likely to need to be taken into account, as are prices of various other products sold by the retail fuel site. Typically, a plurality of retail fuel sites operate in a particular region, and prices charged by different retail fuel sites in a particular region will routinely need to be taken into account. Additionally, prices charged in different regions in associated retail fuel sites may also need to be taken into account.

Traditionally, prices at which retail fuel sites sell fuel have been determined by skilled analysts who have mentally collated and processed data representing various parameters which need to be taken into account. Having carried out this processing, analysts can typically determine pricing, often convening at a meeting at which a plurality of pricing analysts make various strategy decisions.

More recently, automated systems for determining retail fuel prices have been used. In these automated systems data required for determining pricing is collected and provided to a pricing system which is often located remotely from the retail site. The pricing system uses the provided data together with other information to determine information useful for optimising fuel prices at the retail site. The other information may include a desired pricing strategy such as pricing that optimises sales volumes or that optimises retail site profit. The information generated by the pricing system generally takes the form of recommended pricing for fuels that satisfies the desired pricing strategy, but may also include other useful information such as reports and predictions of competitor prices. There remains a need for improvements in pricing systems and methods.

### SUMMARY

It is an object of the invention to provide improvements in systems and methods for displaying fuel price data to users of pricing systems.

According to a first aspect of the invention there is provided a method of displaying fuel price data, the method being implemented in a computer comprising a memory in communication with a processor, the method comprising: receiving, as input to the processor, a plurality of fuel price data display components, each fuel price data display component being configured to display data fuel price data; receiving, as input to the processor, a search interface configured to receive input data indicating a search criterion associated with fuel price data; receiving, as input to the processor, data indicating a link between the search interface and one or more of the plurality of fuel price data display components; and displaying, on a display device coupled to the computer, the fuel price data, wherein the fuel price data is displayed in the one or more fuel price data display components linked to the search interface based upon the search criterion.

By displaying fuel price data in a fuel price data display component linked to a search interface, data displayed in the fuel price data display component can be quickly updated based upon a change made in the search interface. Using the method of the first aspect a user may for example configure a pricing page with fuel price data display components to facilitate a pricing task based upon one or more retail fuel sites and the fuel price data display components can be updated to display the same data for different retail fuel sites in a straightforward manner.

The method may further comprise displaying, on the display device, the search interface and receiving, as input to the search interface, the search criterion.

The method may further comprise: receiving, as input to the processor, a further search interface configured to receive further input data indicating a further search criterion associated with one or more retail fuel sites of the plurality of retail fuel sites; receiving, as input to the processor, data indicating a link between the further search interface and one or more of the plurality of fuel price data display components; and displaying, on the display device, the fuel price data, wherein the fuel price data is displayed in the one or more fuel price data display components linked to the further search component based upon the further search criterion. A pricing page may for example be configured to display data associated with different retail fuel sites to facilitate comparison of the retail fuel sites.

Displaying the fuel price data may comprise, for each of the one or more fuel price data display components linked to the further search component, generating a graphical representation of the fuel price data associated with the fuel price data display component. The data may be displayed in any convenient form, for example to assist with particular fuel pricing tasks.

Receiving data indicating a link between the search interface and one or more of the plurality of fuel price data display components may comprise: displaying, on the display device, the plurality of fuel price data display components; displaying, on the display device, the search interface; and receiving user input indicating a relationship between the search interface and one or more of the plurality of fuel price data display components. Alternatively the fuel price data display components may be generated based upon the search interface and automatically linked to the search interface. The method may further comprise storing the received user input.

The method may further comprise processing the criterion to determine the fuel price data to be displayed. Displaying the fuel price data based upon the search criterion may comprise: selecting one or more retail fuel sites of a plurality of retail fuel sites based upon the criterion; and displaying fuel price data associated with the selected one or more retail fuel sites.

The search criterion may indicate a fuel price property, and selecting one or more retail fuel sites may comprise, for each of the one or more retail fuel sites, displaying fuel price data associated with the retail fuel site if the fuel price data associated with the retail fuel site satisfies the fuel price property. The criterion may for example identify a subset of a plurality of retail fuel sites, for example all sites that are performing relative to a target in a way defined by the criterion. The criterion may for example specify sites for which fuel sales are a predetermined percentage below a target fuel sales for the site or for example sites that have a margin outside of a predetermined range of a target margin.

The fuel price data may comprise data associated with one or more fuel price properties selected from the group consisting of: fuel sales at one or more retail fuel sites; a fuel sales target at one or more retail fuel sites; a fuel price of one or more fuel types; and one or more competitor sites associated with one or more retail fuel sites.

According to a second embodiment of the invention there is provided a method of displaying fuel price data, the method being implemented in a computer comprising a memory in communication with a processor, the method comprising: receiving, as input to the processor, first fuel price data associated with a fuel location, the first fuel price data being associated with the fuel location at a first time; receiving, as input to the processor, second fuel price data associated with the fuel location, the second fuel price data being associated with the fuel location at a second time; receiving, as input to the processor, an input time; and selecting, by the processor, one of the first fuel price data and the second fuel price data for display based upon the input time.

The second embodiment of the invention therefore provides a convenient interface for selection of fuel price data to be displayed.

The method may further comprise displaying the one of the first fuel price data and the second fuel price data.

The method may further comprise receiving a graphical representation of the fuel location, wherein the fuel price data is displayed based upon the graphical representation of the fuel location. The graphical representation of the fuel location may comprise a map associated with the fuel location. The selected fuel price data may for example be overlaid on a map.

The fuel price data may comprise data associated with one or more retail fuel sites, wherein the fuel location is a location associated with the one or more retail fuel sites. For example the fuel price data may be displayed such that a relationship between fuel price data associated with particular retail fuel sites and the location of the retail fuel sites is represented.

Selecting one of the first fuel price data and the second fuel price data for display may comprise selecting the sequence in which the first fuel price data and the second fuel price data are displayed. For example, each of the first fuel price data and second fuel price data may be displayed sequentially based upon the input time.

The method may further comprise receiving further fuel price data associated with the fuel location and displaying the further fuel price data based upon the input time. For example, a data set may be received providing the fuel price data at a plurality of times and the input time may be used to select a subset of the data set to be displayed. The fuel price data may for example be displayed as a sequence of frames overlaid on a graphical representation of a location to represent change of the fuel price data with time for a location.

The input time may comprise a user input indicating a time for which fuel price data associated with the fuel location is to be displayed. Receiving an input time may comprise displaying a user interface element indicating a time, and the input time may be received based upon a user input to the user interface element.

The fuel price data may comprise data associated with one or more fuel price properties selected from the group consisting of: fuel sales at one or more retail fuel sites; a fuel sales target at one or more retail fuel sites; a fuel price of one or more fuel types; and one or more competitor sites associated with one or more retail fuel sites.

According to a third aspect of the invention there is provided a method of displaying fuel price data, the method being implemented in a computer comprising a memory in communication with a processor, the method comprising: receiving, as input to the processor, first fuel price data associated with a fuel location, the first fuel price data being associated with the fuel location at a first time; receiving, as input to the processor, second fuel price data associated with the fuel location, the second fuel price data being associated with the fuel location at a second time; displaying, on a display device coupled to the processor, a first graphical representation of the first fuel price data; and displaying, on the display device, a second graphical representation of the second fuel price data, wherein the first graphical representation and the second graphical representation are displayed in a sequence based upon the first time and second time.

The third aspect of the invention allows fuel price data to be displayed such that a relationship between fuel price data associated with particular retail fuel sites and the location of the retail fuel sites is represented.

The graphical representation may comprise a map associated with the fuel location.

Displaying the first graphical representation of the first fuel price data may comprise overlaying the fuel price data on the map. The fuel price data may be represented on the map in any convenient form, for example using a heat map in which different colours represent different values of the fuel price data.

The fuel price data may comprise data associated with one or more retail fuel sites, wherein the fuel location is a location associated with the one or more retail fuel sites.

The method may further comprise receiving further fuel price data associated with the fuel location and displaying a further graphical representation of the further fuel price data. A plurality of graphical representations may be displayed such that change with time of fuel price data in a particular location is represented.

The method may further comprise receiving an input time, and receiving the first fuel price data and the second fuel price data may comprise selecting the first fuel price data and the second fuel price data from a plurality of fuel price data based upon the input time. Receiving an input time may comprise displaying a user interface element indicating a time, and the input time may be received based upon a user input to the user interface element.

The fuel price data may comprise data associated with one or more fuel price properties selected from the group consisting of: fuel sales at one or more retail fuel sites; a fuel sales target at one or more retail fuel sites; a fuel price of one or more fuel types; and one or more competitor sites associated with one or more retail fuel sites.

According to a fourth aspect of the invention there is provided a method of receiving fuel price data associated with a retail fuel site, the method being implemented in a computer comprising a memory in communication with a processor, the method comprising: receiving, as input to the processor, a location associated with the retail fuel site; and displaying, on a display device coupled to the computer, an interface, the interface comprising a graphical representation associated with the location and being arranged to receive user input providing fuel price data associated with the retail fuel site.

In prior art methods fuel price data is typically input by a user using a text based interface, and the fourth aspect provides an improved interface for a user to input fuel price data, for example as part of a pricing page used by a fuel pricing analyst. The fuel price data may therefore be received as user input to the interface.

The graphical representation associated with the location may comprise a graphical representation of a region surrounding the location. The graphical representation associated with the location may comprise map data associated with the location. For example, the graphical representation may provide a representation of information associated with the retail fuel site based upon the location to assist a pricing analyst. The interface may comprise an indicator associated with the location. The indicator may comprise a user selectable indicator, and the method may further comprise receiving a user selection of the indicator and displaying a user input interface arranged to receive the fuel price data associated with the retail fuel site. The user input interface may indicate fuel price data associated with the retail fuel site. That is, the user input interface may, when selected for display, display current fuel price data that a user can modify.

The method may further comprise: receiving, as input to the processor, a plurality of locations, each location associated with a respective one of a plurality of retail fuel sites; and displaying an interface comprising a graphical representation associated with each location of the plurality of locations, the graphical representation being arranged to receive fuel price data associated with each of the plurality of retail fuel sites.

The method may further comprise receiving, as input to the interface, fuel price data associated with retail fuel site; and generating output data associated with the retail fuel site based upon the received fuel price data. The fuel price data may be received as input from a user. The received fuel price data may be stored in the memory, for example as updated fuel price data that replaces previously stored fuel price data.

The fuel price data may comprise a price associated with one or more fuel types of the retail fuel site.

According to a fifth aspect of the invention there is provided a method of displaying fuel price data, the method being implemented in a computer comprising a memory in communication with a processor, the method comprising: receiving, as input to the processor, a criterion associated with one or more properties of fuel price data; processing, by the processor, fuel price data associated with each of a plurality of retail fuel sites based upon the criterion; if fuel price data associated with a retail fuel site satisfies the criterion, outputting, by the processor, notification data indicating the associated retail fuel site; and repeating the steps of processing the fuel price data and outputting notification data at predetermined time intervals.

The fifth aspect of the invention provides periodic notifications that allow changes to fuel price data, which generally changes regularly, to be automatically identified. For example, a user may input one or more criterion to check at predetermined intervals whether a property of retail fuel sites associated with the user has changed.

The method may further comprise generating data indicating whether each of the plurality of retail fuel sites satisfies the criterion based upon the processing fuel price data associated with each retail fuel site, wherein the output notification data is based upon the generated data.

Receiving a criterion associated with one or more properties of fuel price data may comprise displaying, on a display device coupled to the processor, a user interface arranged to receive user input associated with the criterion.

Outputting notification data may comprise displaying, on a display device coupled to the processor, a graphical indication as part of a pricing page associated with a user. The indication may for example be displayed as part of a pricing page associated with the user. Alternatively or additionally outputting notification data may comprise displaying, on a display device coupled to the processor, a user interface, the user interface displaying data associated with the retail fuel site that satisfies the criterion. The data associated with the retail fuel site that is displayed may be based upon the fuel price data associated with the retail fuel site upon which the criterion is based.

The user interface may be selected from a plurality of user interfaces based upon the criterion.

The method may further comprise receiving the predetermined time interval from a user. The time interval generally indicates a period after which stored data is checked to determine if new data satisfies the criterion.

The fuel price data may comprise data associated with one or more fuel price properties selected from the group consisting of: fuel sales at one or more retail fuel sites; a fuel sales target at one or more retail fuel sites; a fuel price of one or more fuel types; and one or more competitor sites associated with one or more retail fuel sites.

The criterion associated with one or more properties of fuel price data may be based upon volume sales at a retail fuel site and/or a margin associated with fuel sales at the retail fuel site.

According to a sixth aspect of the invention there is provided a method of displaying fuel price data, the method being implemented in a computer comprising a memory in communication with a processor, the method comprising: receiving, as input to the processor, fuel price data; receiving, as input to the processor, data indicating an interface of a plurality of interfaces, each of the plurality of interfaces having a respective associated format; displaying, on a display device coupled to the computer, the fuel price data based upon the data indicating an interface; and displaying, on the display device, information associated with the displayed fuel price data and the format associated with the interface.

The sixth aspect of the invention provides tailored additional information that may be useful given the data that is displayed.

The method may further comprise processing the fuel price data, wherein the displayed information is based upon the processing. Processing the fuel price data may comprise determining a property of the fuel price data. The information associated with the displayed fuel price data may be selected from a data store of information based upon the displayed fuel price data.

Each of the plurality of interfaces may be arranged to display fuel price data in a predetermined format. The information may be displayed based upon the predetermined format associated with the indicated interface. For example, the format may be generally used to determine a particular aspect of the displayed data and the information that is displayed may provide information on the particular aspect. The information may comprise information associated with the interface.

The method may further comprise displaying the fuel price data based upon data indicating a further interface, wherein the fuel price data is displayed based upon the data indicating a further interface simultaneously with the display of the fuel price data based upon the data indicating an interface. The fuel price data may therefore be displayed as part of a pricing page in which a plurality of interfaces are displayed, and each of the interfaces may have an associated set of further data that may be displayed. For example, each interface may comprise a user selectable component that, upon selection by a user, causes further information associated with the interface to be displayed. In this way useful information associated with each interface can be provided to a user without the user being required to navigate a menu associated with all of the interfaces to identify the further information.

The further information may be displayed in an area of the display device determined based upon the displayed fuel price data. For example, the further information may be displayed adjacent to or overlaid on the interface.

The fuel price data may comprise data associated with one or more fuel price properties selected from the group consisting of: fuel sales at one or more retail fuel sites; a fuel sales target at one or more retail fuel sites; a fuel price of one or more fuel types; and one or more competitor sites associated with one or more retail fuel sites.

According to a seventh aspect of the invention there is provided a method of displaying fuel price data, the method being implemented in a computer comprising a memory in communication with a processor, the method comprising: receiving, as input to the processor, fuel price data associated with a retail fuel site, the fuel price data comprising a plurality of properties associated with a fuel price of the retail fuel site; displaying, on a display device coupled to the processor, a user interface, the user interface comprising an interface associated with each of the plurality of properties; receiving, as input to the user interface, data indicating a change associated with at least one of the plurality of properties; processing, by the processor, the fuel price data based upon the data indicating a change to generate predicted fuel price data; and displaying, on the display device, the predicted fuel price data.

The seventh aspect of the invention allows the effect of a plurality of properties to be displayed and therefore provides a tool for analysis of the effect. The properties may be displayed in such a way that they provide a visualization of the effect of a change to one or more of the plurality of properties.

Processing the fuel price data based upon the data indicating a change to generate predicted fuel price data may comprise evaluating a model representing a relationship between the plurality of properties. Evaluating a model representing a relationship between the plurality of properties may comprise: assigning a value to a parameter of the model based upon the data indicating a change; and evaluating the model based upon the assigned value. The model may be a fuel price model such as a Bayesian inference model.

The plurality of properties may comprise properties selected from the group consisting of: a price associated with one or more fuel types; a retail fuel site policy; and a relationship between fuel prices of the retail fuel site and fuel prices at one or more competitor retail fuel sites.

The predicted fuel price data may comprise data associated with one or more properties associated with the retail fuel site selected from the group consisting of: a margin associated with the retail fuel site; and a fuel sales volume associated with the retail fuel site; a profit associated with the retail fuel site.

Displaying the predicted fuel price data may comprise: processing the received fuel price data to generate predicted fuel price data without the change associated with at least one of the plurality of properties; and displaying the predicted fuel price data based upon the predicted fuel price data without the change. For example, the effect of the change may be compared with corresponding data if the change is not made.

The method may further comprise displaying a user interface component for displaying the predicted fuel price data, wherein the user interface component is automatically updated based upon the processing.

Each aspect of the invention may form part of a fuel pricing interface such as a pricing page of a fuel pricing system. The fuel pricing interface may for example provide data useful for a pricing analyst to analyse fuel prices and recommend and/or automatically implement pricing recommendations to one or more retail fuel stores.

Aspects of the invention can be combined, for example in a fuel pricing interface. For example, the fuel price display of some aspects may be provided in one or more components linked to a search component such that the fuel price display is updated based upon a change to the search component.

Aspects of the invention can be implemented in any convenient form. For example computer programs may be provided to carry out the methods described herein. Such computer programs may be carried on appropriate computer readable media which term includes appropriate non-transient tangible storage devices (e.g. discs). Aspects of the invention can also be implemented by way of appropriately programmed computers and other apparatus.

### BRIEF DESCRIPTION OF THE DRAWINGS

Embodiments of the invention will now be described, by way of example, with reference to the accompanying drawings, in which:

FIG. 1 is a schematic illustration of part of a network of associated retail fuel sites in communication with a pricing system;

FIG. 2 is a schematic illustration of the pricing system of FIG. 1;

FIG. 2A is a schematic functional block diagram of part of the pricing system of FIG. 1;

FIG. 3 is a schematic illustration showing a computer associated with the pricing system of FIG. 2 in further detail;

FIGS. 4 to 6 are pricing page configurations for displaying information to a user;

FIG. 7 shows part of a pricing page in more detail;

FIG. 8 shows part of a pricing page in more detail; and

FIGS. 9 and 10 are further pricing page configurations for displaying information to a user;

FIG. 11 is an entity diagram of a database suitable for storing and managing data to be displayed as part of the pricing page of FIG. 5; and

FIG. 12 is a schematic illustration of data processing carried out to generate fuel price data.

### DETAILED DESCRIPTION

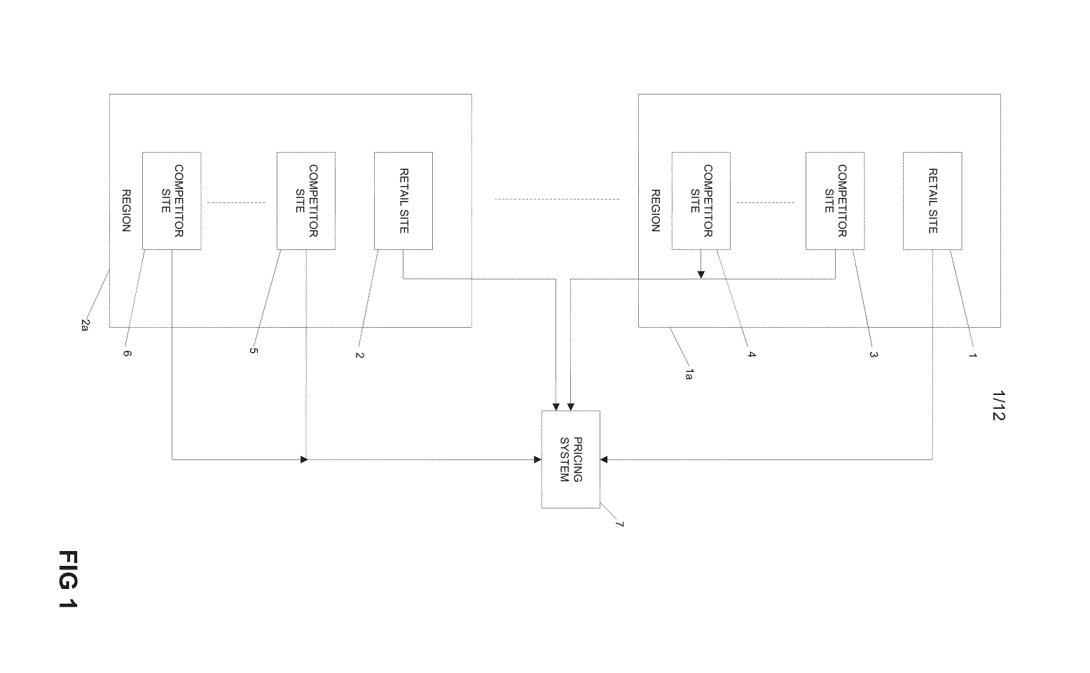

Referring first to FIG. 1 part of a network of associated retail fuel sites, 1, 2 is illustrated. Each of the associated retail fuel sites may be, for example, owned or operated by a single commercial entity, or may be supplied by a particular fuel supplier. Each of the associated retail fuel sites 1, 2 has an associated region 1a, 2a which defines a geographical area in which competitor retail sites 3, 4, 5, 6 are considered to be direct competitors. That is, competitor sites 3, 4 which lie in region 1a are direct competitors of the first associated retail site 1 and competitor sites 5, 6 which lie in region 2a are direct competitors of the second associated retail site 2 such that sales of sites lying in region 1a affect sales of other sites lying in region 1a and sales of sites lying in region 2a affect sales of other sites lying in region 2a. It will be appreciated that a wider area such as a country will generally be divided into a plurality of regions in which retail sites compete with competitor sites. Regions may be selected based upon a geographical region such as an area surrounding a city or may be selected based upon other factors that determine competing sites such as sites located along a particular highway.

Associated retail fuel sites 1, 2 in the network of associated retail fuel sites may further be arranged in networks indicating groups of associated retail fuel sites that share a common pricing strategy such as retail fuel sites located at motorway service stations or retail fuel sites located in urban or rural areas. Additionally, associated retail fuel sites may be operated under various contract types and retail fuel sites operating under particular contract types may also be arranged into networks. Examples of contract types under which retail fuel sites may operate may include “company owned, company operated”, “company owned, franchisee operated”, “dealer owned, dealer operated” and “company owned, dealer operated”. The associated retail fuel sites and competitor retail fuel sites, networks and regions are used to construct a model defining interrelationships between associated retail fuel sites and competitor retail fuel sites. Where changes to the networks and regions subsequently occur, the model defining interrelationships between the sites is updated to reflect the changes.

A pricing system 7 is arranged to receive various data including data associated with each of the associated retail sites 1, 2 and data associated with competitor sites 3, 4, 5, 6. The pricing system 7 is arranged to process the received data and to generate various output data, in particular an optimal pricing strategy for each of the products at each of the associated retail sites 1, 2 based upon the provided information.

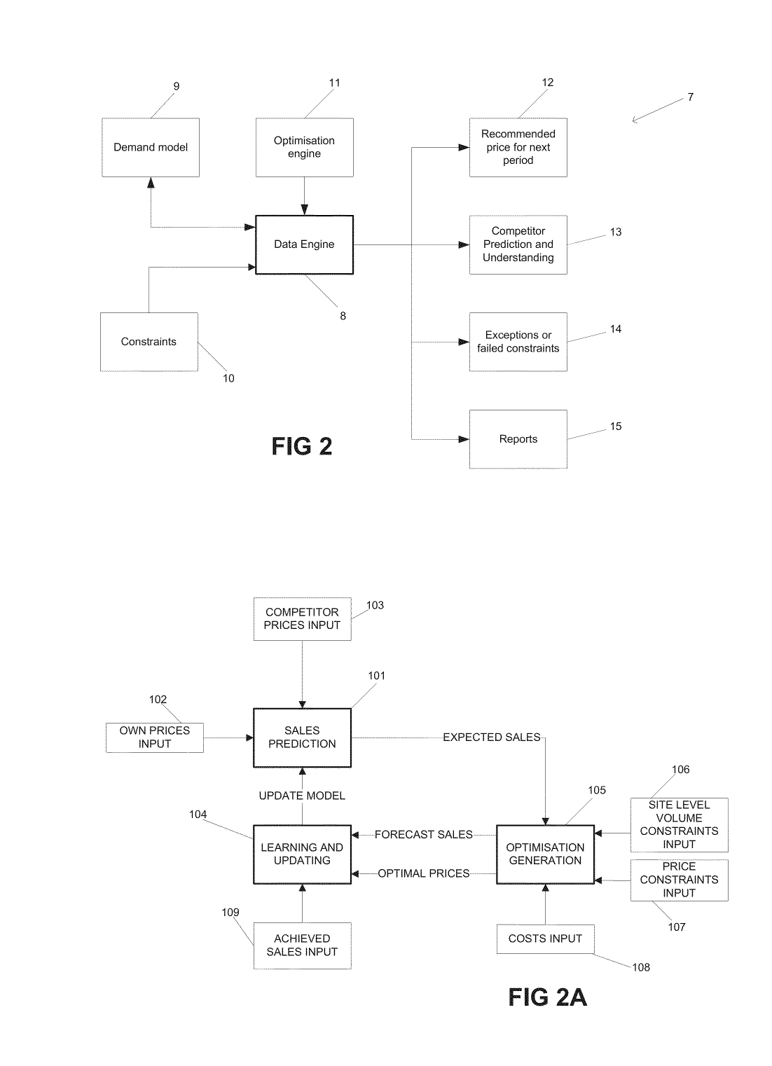

FIG. 2 shows operation of the pricing system 7 of FIG. 1 in more detail. It can be seen that the pricing system 7 takes various data as input, and generates various data as output as described above. Specifically, a data engine 8 takes as input a demand model 9 and constraints 10 and uses an optimisation engine 11. The demand model 9 forecasts sales volume for each product by site and time period. The demand model 9 uses past sales history at each site together with site prices and competitor site prices as well as elasticity values indicating sensitivity of customers to price changes for each product at each associated retail site 1, 2 and time period. The elasticity values provide an estimate of how demand for a particular product is likely to vary in response to price changes, either by an associated retail site 1, 2 or a competitor site 3, 4, 5, 6, and may be determined in an offline process using linear or non-linear regression modelling techniques based upon historic sales and price data. For example, stepwise or ridge regression may be used which are effective techniques for modelling historic price data which is generally highly correlated.

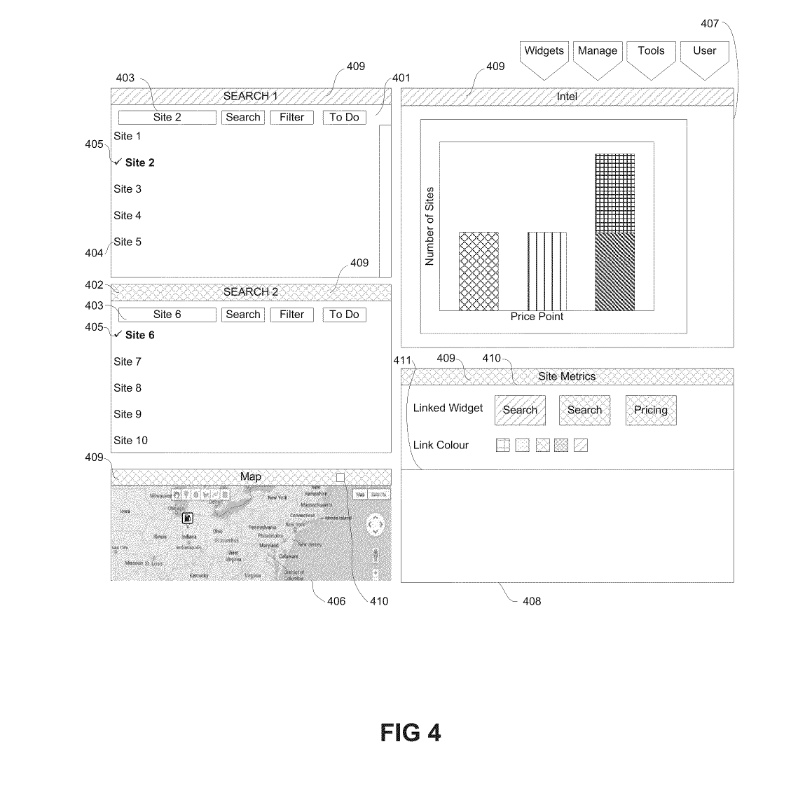

The retail site data and competitor site data may be provided to the pricing system 7 using a data link which automatically provides retail site data to the pricing system 7, for example at the end of each day. Competitor data is collected by the associated retail site 1, 2 and provided to the pricing system 7 in any convenient way, for example by using the same data link as used to provide retail site data or alternatively using mobile computing devices which are used by operatives to collect the competitor data from the competitor site and which provide the competitor data to the pricing system 7 over wireless telecommunications. Alternatively, data may be provided in any convenient way. An example user interface suitable for inputting site and competitor prices is described below with reference to FIG. 4.

The constraints 10 allows a user to specify rules defining pricing strategies by site and/or product. The rules take the form of price differentials and ranges which it is desirable are satisfied by prices at an associated retail site 1, 2. Price differentials determine a pricing position of a site relative to other competitor sites within a region. Price differentials are used to indicate a range of acceptable prices for a particular product relative to corresponding competitor prices within which the data engine 8 seeks to determine product prices which satisfy the specified price differentials. Price differentials may provide different ranges of acceptable prices relative to different competitors and in particular may include a differential relative to a main competitor and additionally or alternatively may include a differential relative to a different site in the network of associated retail fuel sites 1, 2, such that pricing at a first site in the network generally follows pricing at a second site in the network.

Price differentials may either be constraint-type differentials indicating constraints on prices that should be satisfied, often relative to a main competitor for a particular site, or guide-type differentials, which are optional constraints that are to be satisfied where possible, but which may be ignored if they cannot be met. Where a guide-type differential is not satisfied by pricing determined for a particular site the site may be added to a list of sites to be manually reviewed, for example by an expert analyst or a manager at an associated retail fuel site 1, 2. Alternatively, rules may be relaxed either manually or automatically such that optimal prices can be determined. That is, where it is determined that all of the currently specified rules cannot be satisfied, one or more of the rules may be made less restrictive. The one or more rules may be selected based upon an order which specifies the order in which rules should be relaxed if all of the rules cannot be satisfied.

The optimisation engine 11 is used to determine a set of prices which maximise some objective, whilst attempting to satisfy the rules specified by the constraints 10. In general terms, price optimisation is concerned with balancing profit with volume sales within specified price constraints. The optimisation engine takes as input a policy which indicates the relative importance of profit and volume sales for the optimisation and may be provided as a value between 0 and 100 where 0 indicates that profit is to be maximised and 100 indicates that volume is to be maximised, and values between 0 and 100 indicate relative proportions of profit and volume maximisation. The optimisation engine 11 may additionally be provided with data indicating information about the current market environment which can be taken into account in the generation of prices such as, for example data indicating expected variation in sales in a region or network. Examples of additional information may include data indicating that an event caused a reduction of sales on a particular day, or that a forthcoming event is likely to cause high sales such that strategy should be modified, for example to maximise profit.

The data engine 8 uses the demand model 9, constraints 10 and optimisation engine 11 to generate a recommended price 12 for each product at each associated retail fuel site 1, 2 in the network of associated retail fuel sites using modelling techniques well known in the art. For example, sequential quadratic programming, active set solvers, interior point solvers or other suitable non-linear optimisation techniques may be used to generate the recommended price 12. Additionally, a daily error-correction process such as a Kalman filter or dynamic linear model may be used to update model parameters in light of prediction errors. The data engine 8 may additionally provide output data 13 which can be used to predict competitor price changes, and to understand competitor pricing policies. Data 14 is generated indicating constraints which are specified by the constraints 10 but which are not satisfied by the recommended price 12. Reports 15 may also be generated by the data engine 8. The output data may be provided to the associated retail site 1, 2 in any convenient way, for example using the same method as that used to provide retail site and competitor data to the pricing system 7 from the retail site.

Referring now to FIG. 2A, a schematic functional block diagram of the pricing system is shown. The system has three functional blocks 101, 104, 105 which each take data as input, both from external sources and additionally from others of the three functional blocks, and each generate output data.

In more detail, a sales prediction block 101 takes as input own prices 102 and competitor prices 103 together with an updated model generated at a learning and updating block 104, and outputs expected sales for the current period. The expected sales output from the sales prediction block 101 are input to an optimisation generation block 105 which also takes as input site level volume constraints 106 (indicating minimum required volume sales for a site), price constraints 107 and costs 108. The optimisation generation block processes its inputs and generates a set of optimal prices and a corresponding forecast of sales, the forecast of sales being based upon the generated set of optimal prices. The forecast of sales and the optimal prices output from the optimisation generation block 105 is input to the learning and updating block 104, together with achieved sales during the period for which the optimal prices were generated and used. The updated model that is passed to the sales prediction block 101 is generated at the learning and updating block 104 based upon the forecast sales for the period and the achieved sales for the period. In this way, the sales prediction for the next period is improved.

The optimal prices for an associated retail fuel site i, generated at the optimisation generation block 105 of FIG. 2A, can be determined by solving an optimisation problem of the form shown in equation (1):

$$maximise {\sum }_{i = 1}^{m} {\sum }_{k = 1}^{p} {G}_{tik} \qquad ( 1 )$$

with respect to own prices: {Pₜᵢₖ}_{i=1 . . . m,k=1 . . . p};
subject to price constraints: {gₗ_{ᵢₖ}≧0}ₗ_{ᵢₖ}_{=1 . . . q}_{ᵢₖ}_{,i=1 . . . m,k=1 . . . p}; and

$${\{ {\sum }_{k} {V}_{tik} \geq {L}_{ti} \}}_{i = 1 … m}$$

site level volume constraints:
where:
i is an index indicating an ith one of m associated retail fuel sites;
j is an index indicating a jth one of n competitor sites;
k is an index indicating a kth one of p fuel products;
t is a time period;
Gₜᵢₖ indicates gross profit from sale of grade k at site i in time period t and can be modelled in the form shown below in equation (3);
Pₜᵢₖ indicates the current price of fuel product k at associated retail fuel site i and time t;
lᵢₖ is an index indicating an lᵢₖth one of qᵢₖ price constraints indicating constraints on price such as a constraint on price difference between own and competitor products for a particular fuel product k;
gₗ_{ᵢₖ} models the qᵢₖ price constraints as a linear function of own price, cost and competing prices for site i and fuel product k and has the form shown in equation (4) below;
Vₜᵢₖ indicates sales volume in time period t at site i for grade k and can be modelled in the form shown below in equation (2); and
Lₜᵢ indicates a minimum volume target for sales in time period t at site i.
   Sales volume can be modelled in the form shown in equation (2):

Vₜᵢₖ=f(Vₛᵢₖ,Pₜᵢₖ,Pₜⱼₖ) (2)

where:
Vₛᵢₖ indicates previous sales at a time s<t;
Pₜⱼₖ indicates the current price of fuel product k at competitor retail fuel site j and time t; and
f is a model describing the relationships (referred to as elasticities) between own prices and competitor prices, based upon previous sales Vₛᵢₖ and generally is a log-log or log-linear model. The coefficients of the price terms of f are price elasticities. Further details of the form and estimation of the model can be found in, for example the following, which are herein incorporated by reference: Singh, M. G., Bennavail, J.-C, (1993) “Experiments in the use of a knowledge support system for the pricing of gasoline products”, Information & Decision Technologies 18(6): 427-442; Krasteva, E., Singh, M. G., Sotirov, G., Bennavail, J.-C., and Mincoff, N., (1994) “Model Building for pricing decision making in an uncertain environment, Proc. IEEE International Conference on Systems, Man and Cybernetics”, San Antonio; and Bitran, G., Caldentey, R. and Mondeschein, S. (1998) “Coordinating clearance markdown sales of seasonal products in retail chains”, Operations Research 46(5): 609-624.
   Accordingly gross profit Gₜᵢₖ can be modelled as shown in equation (3):

$${G}_{tik} = ( \frac{{P}_{tik}}{1 + v} - {C}_{tik} ) {V}_{tik} = ( \frac{{P}_{tik}}{1 + v} - {C}_{tik} ) f ( {V}_{sik} , {P}_{tik} , {P}_{tjk} ) \qquad ( 3 )$$

where:
Pₜᵢₖ indicates current price of fuel product k at site i and time t as above;
Cₜᵢₖ indicates direct sales costs for fuel product k in time period t at site i; and
v is the applicable sales tax rate.

The price constraints gₗ_{ᵢₖ}, can be modelled in the form shown in equation (4):

gₗ_{ᵢₖ}(Pₜᵢₖ,Cₜᵢₖ,Pₜⱼₖ)≧0 (4)

where Pₜᵢₖ, Cₜᵢₖ and Pₜⱼₖ are as described above.

The optimisation problem of equation (1) can be solved using non-linear optimisation techniques well known in the art such as those described in Gill, P. E., Murray, W., and Wright, M. H., “Practical Optimisation” (1981), Academic Press, which is herein incorporated by reference. The optimisation provides a set of prices Pₜᵢₖ, indicating an optimal price at each site for each fuel product given various constraints that are applicable at the current time t.

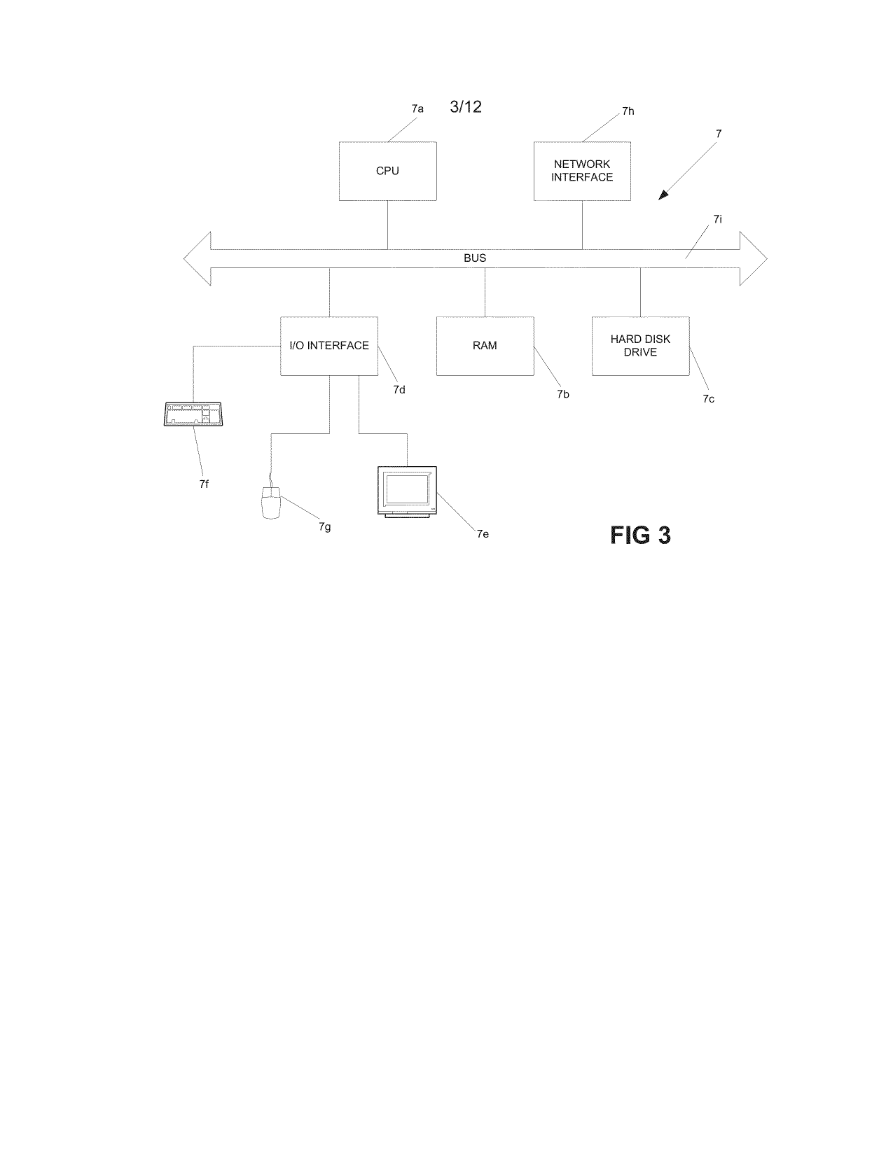

FIG. 3 shows a computer associated with the pricing system 7 of the system of FIG. 1 in further detail. It can be seen that the computer associated with the pricing system comprises a CPU 7a which is configured to read and execute instructions stored in a volatile memory 7b which takes the form of a random access memory. The volatile memory 7b stores instructions for execution by the CPU 7a and data used by those instructions. For example, in use, software used to determine optimal prices for retail fuel sites may be stored in volatile memory 7b.

The computer associated with the pricing system 7 further comprises non-volatile storage in the form of a hard disc drive 7c. Data such as retail fuel site data and competitor site data may be stored in the hard disc drive 7c. The computer associated with the pricing system 7 further comprises an I/O interface 7d to which are connected peripheral devices used in connection with the computer associated with the pricing system 7. The computer associated with the pricing system 7 has a display 7e configured so as to display output from the data engine. Input devices are also connected to the I/O interface 7d. Such input devices include a keyboard 7f, and a mouse 7g which allow user interaction with the data engine. A network interface 7h allows the computer associated with the pricing system 7 to be connected to an appropriate computer network so as to receive and transmit data from and to other computing devices such as computing devices provided at the retail fuel sites. The CPU 7a, volatile memory 7b, hard disc drive 7c, I/O interface 7d, and network interface 7h, are connected together by a bus 7i.

It has been indicated above that associated retail fuel site (referred to as “sites” in the description below) and competitor site prices are provided to the pricing system 7. The following describes various pricing page components that may be configured and displayed as part of a pricing page such as the pricing page described in US Patent Publication Number US2012/0198366, which is hereby incorporated by reference. The pricing page is a pricing page for a user associated with one or more associated retail fuel sites. The user may for example be a fuel price analyst or a manager of a retail fuel site. As indicated above, various output data relevant to each site is generated and the generated output data may be displayed in various forms in pricing page components. The pricing page components may be configured such that a user can control the data associated with one or more sites that is displayed. Referring first to FIG. 4, a pricing page comprising a first search interface 401 and a second search interface 402 is shown. Each of the first and second search interfaces 401, 402 comprises a search entry box 403 into which a search term can be entered by a user and sites that satisfy a criterion specified by the search term are displayed in a search result display area 404.

The criterion specified by the search term may for example be a location and all sites associated with the location may be returned. Alternatively or additionally the criterion may be associated with a site property, for example sites that have a sales volume above or below a predetermined value and/or sites that have a margin above or below a predetermined criterion, and sites that have the associated property may be returned in the search result display area 404.

A user may select one or more sites displayed in search result display area 404. Selected sites are indicated by a site selection indicator 405 and data associated with sites that are selected in a search interface are displayed in one or more site data pricing page components. In particular, each of search interfaces 401, 402 may be linked to one or more site data pricing page components. Data displayed in a site data pricing page component that is linked to a search interface corresponds to sites that are selected in the linked search interface.

FIG. 4 shows three site data pricing page components 406, 407, 408. Each of search interfaces 401, 402 and site data pricing page components 406, 407, 408 comprises a colour coded bar 409 that provides a visual indicator to a user of links between the pricing page components. Each site data pricing page component 406, 407, 408 comprises a link button 410 that when selected by a user causes a link selection interface 411 to be displayed. The link selection interface 411 comprises a colour coded button associated with each of the pricing page components to which the pricing page component 408 can be linked. Upon receipt of a user selection of one of the colour coded button the site data pricing page component is linked to the corresponding search interface and data associated with a selected one or more sites of the search interface is displayed in the site data pricing page component.

As illustrated in FIG. 4 by shading, search interface 401 is linked to site data pricing page component 407 and search interface 402 is linked to site data pricing page components 406 and 408. If the site selection in search interface 401 is changed such that a new site is selected then the site data pricing page component 407 is modified such that the displayed data is data associated with the new site. The linking of pricing page components in this way allows a user to customise a pricing page to display particular data relevant to the user and/or relevant to a specific task of the user and to quickly and easily update the pricing page to display data associated with different sites such that the data associated with the different sites can be compared.

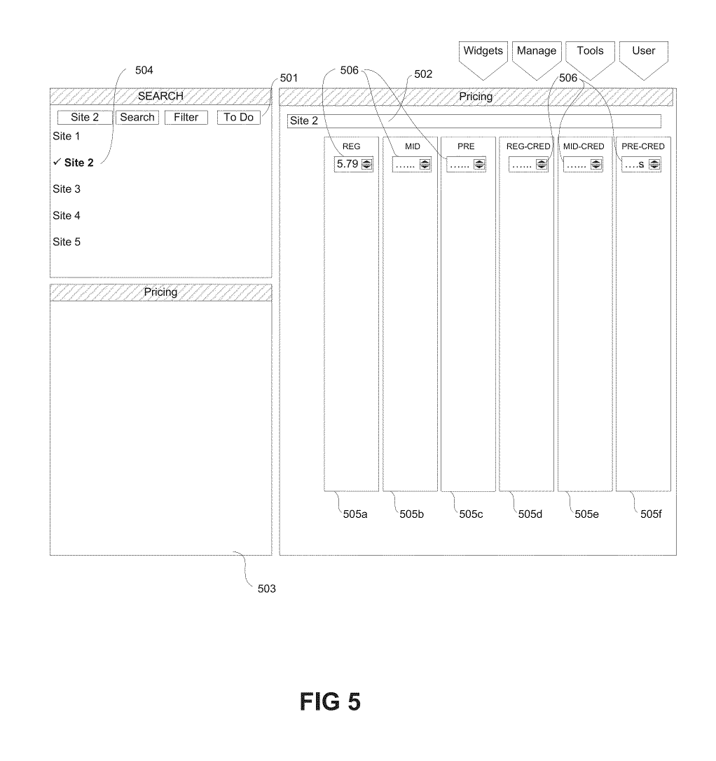

Referring to FIG. 5, a further configuration of a pricing page is shown in which a search interface 501 is linked to each pricing page component 502, 503 such that data associated with a selected site 504 is displayed in each pricing page component. Configuration of the pricing page as shown in FIG. 5 allows a user to display a large amount of information associated with a single site that can be updated to display information associated with different sites in a straightforward way using the linked search interface.

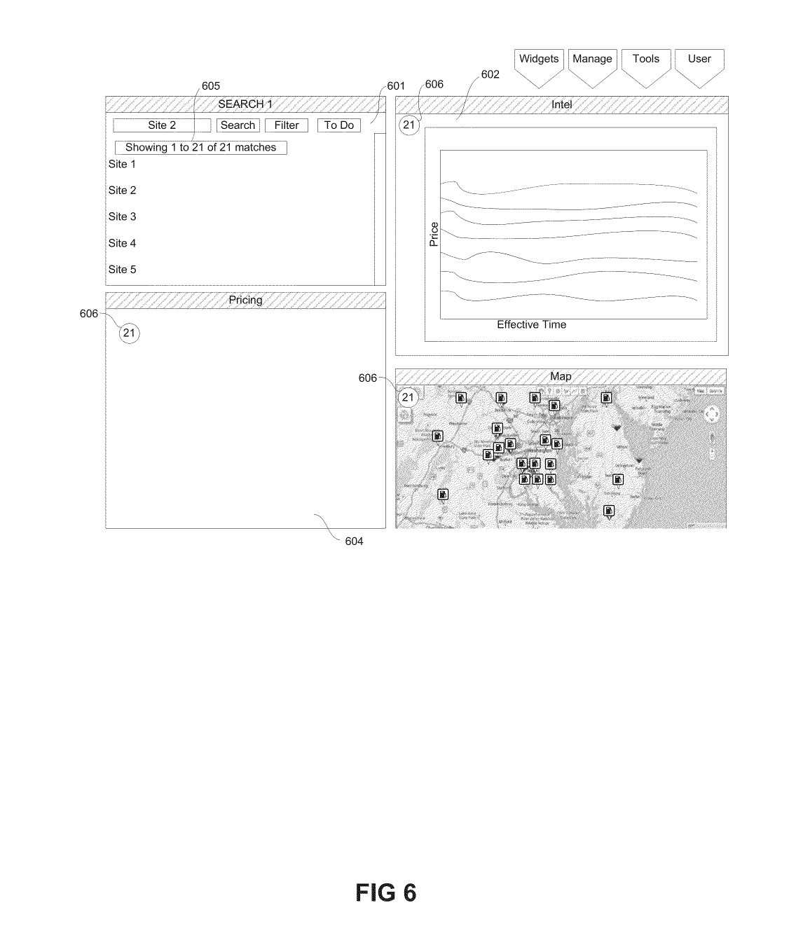

FIG. 6 shows a further configuration of a pricing page in which a search interface 601 is linked to each of pricing page components 602, 603, 604, similarly to the pricing page of FIG. 5. However unlike the pricing page of FIG. 5, each pricing page component 602, 603, 604 is arranged to display information associated with each of the sites returned by a search criterion associated with search interface 601. In particular, as indicated by text box 605, a search criterion entered into search interface 601 by a user returned 21 matches and each of pricing page components 602, 603, 604 displays data associated with each of the 21 matches, as indicated by a site indicator 606 of each of the pricing page components.

The pricing page components may display any suitable information associated with the selected site and/or sites of the search to which the pricing page components are linked. Various pricing page components and associated features will now be described.

It is described above that user interface components may be displayed and a user may input data indicating a link between the user interface components. In one embodiment links between user interface components may be automatically generated when a user interface component is created. For example, each search interface may be provided with an interface that allows a user to create user interface components based upon the search interface such that the created user interface components are linked to the search component, for example by a user dragging an icon from the search interface to create the user interface element. Links between user interface may be removed by a user, for example by selecting an associated button to remove the link.

Data may be automatically updated in a user interface component based upon a search interface in any convenient way as will be known to a person skilled in the art. For example, the search component may be arranged to broadcast data associated with one or more sites and linked widgets may be arranged to listen to broadcast data generated by search components to which the user interface component is linked. For example, each search component may broadcast data in combination with an identifier associated with the search component. Each user interface component may be arranged to process the identified associated with each broadcast data and process the broadcast data if and only if the identifier corresponds to a stored identifier. Each user interface component may therefore be linked to a search component by storing an identifier associated with the search component that the search component provides with each broadcast.

Pricing page component 406 illustrated in FIG. 4 provides a map component indicating a location of the associated site. As shown in pricing page component 603 illustrated in FIG. 6, the map may indicate a location of a plurality of associated sites of a search to which the pricing page component is linked.

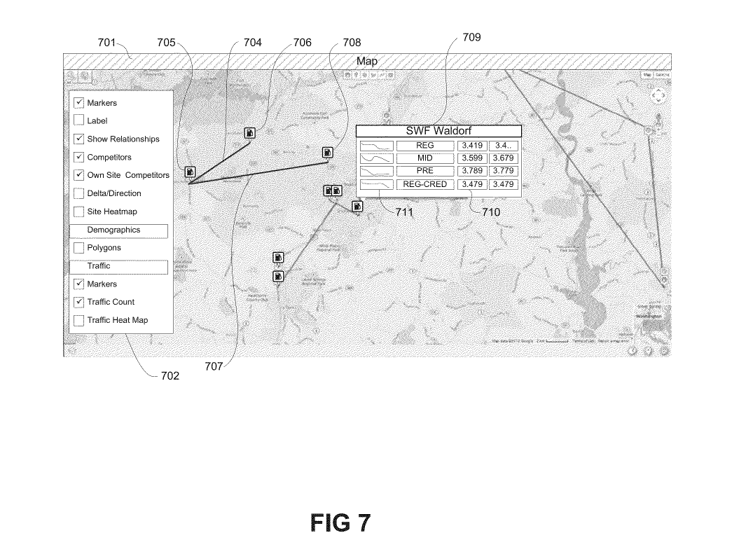

FIG. 7 shows a map component 701 in further detail. As shown in FIG. 7, a key 702 provides a plurality of selection boxes 703 that allow a user to select the information displayed on the map component 701. For example, in the map component of FIG. 7 markers are shown indicating the location of sites selected in a search to which the map component 701 is linked. The sites are colour coded to indicate own sites and competitor sites. Also shown in map component 701 are lines between sites. The lines indicate competitor relationships between sites. For example, a line 704 indicates that own site 705 and competitor site 706 are in direct competition with one another such that sales at site 705 are affected by sales at site 706. A further line 707 indicates a that own site 705 is in further direct competition with competitor site 708. Providing an indication of relationships in this way allows a user to easily identify relationships between sites and provides a visual representation of competitor relationships between the sites that may be useful for pricing fuel at sites.

A user may select sites indicated in a map component, for example by selecting with a cursor an icon corresponding to a site. As shown in FIG. 7, upon selection of an icon corresponding to a site further information 709 may be displayed to the user in the pricing page component. The further information may comprise details of the selected site such as site name. The further information may additionally or alternatively comprise information associated with fuel types of the selected site. The further information associated with fuel types may include a current price associated with each fuel type and/or a graphical indication of change in price associated with each fuel type.

The further information may additionally include a text input box that allows a user to input a price change for a fuel type at the site. Providing a user with an interface to input a price change in a map component allows the user flexibility in how pricing changes are implemented and allows the user to easily take into account properties of the location of the site displayed in the map component to provide improved pricing.

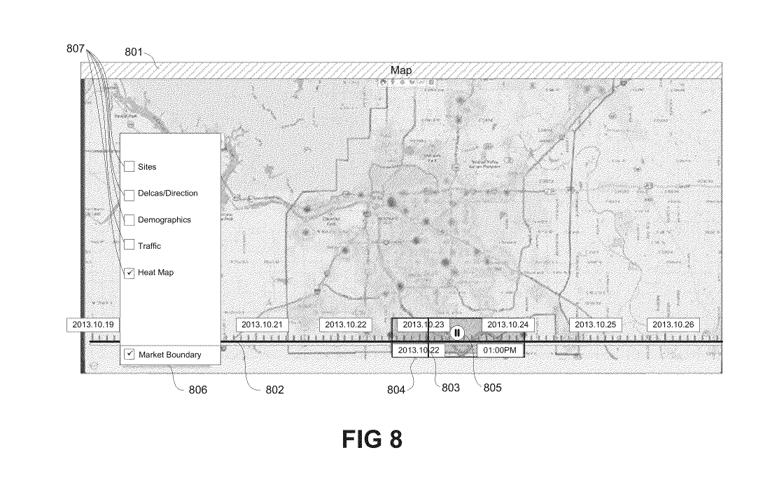

FIG. 8 shows a further map component 801 in which a frame of a sequence of frames associated with the map component is shown. The frame shows a region of interest that may for example be based upon one or more sites associated with a search component to which the map component is linked. Each frame of the sequence of frames associated with the map component provides a graphical illustration of a property of one or more sites in a region, with each frame illustrating the property at an associated time.

A time bar 802 of the map component indicates times for which data is available and for which a frame can be rendered. It will be appreciated that each frame is typically generated for display in real-time based upon stored data associated with the one or more sites. A time indicator 803 indicates a time associated with the currently displayed frame. A sequence indicator box 804 allows a user to select a time period and user selection of a play/pause button 805 causes the frames associated with the time period to be played sequentially so as to provide a time sequence graphical indication of change of the property of the one or more sites in the time period.

A control panel 806 of the map component 801 allows a user to configure the data illustrated in the map component. The control panel provides a plurality of selection boxes that allow a user to select data to be displayed as part of each frame. For example the map component may be configured to display markers indicating a location associated with each site, demographic information, traffic information such as an average number of vehicles that pass a point in a predetermined time period and the data to be displayed. The data to be displayed may be any suitable data such as for example volume sales, price, competitor price changes, volume run rate, effects of a general price change, margin run rate, a difference between own site price and a competitor price such as an average competitor price and an indication of competitor survey compliance.

The data may be displayed in any convenient form. For example, as illustrated in FIG. 8, the data may be displayed in each frame using a heat map that illustrates variation of the data using colour variation, with different colours being illustrated in FIG. 8 by different grey scale intensity. The colour variation may indicate for example a difference in value associated with a site relative to an average value for all sites. It will however be appreciated that the data may be displayed in any convenient form, for example with particular colours being associated with specific values.

Pricing page component 502 illustrated in FIG. 5 shows information associated with six fuel types available at the associated site. The information associated with each of the six fuel types is displayed in columns 505a to 505f. In some embodiments the information that is displayed to a user within a pricing page component such as pricing page component 502 may be configured such that a user can select particular information associated with the site that is displayed within the pricing page component, for example by providing an initial reduced data display to a user that may be expanded upon user selection of the reduced data display to display further information. The information associated with each fuel type may include for example a graphical indicator of an average price for the fuel type, a graphical indicator of a margin for the fuel type, a cost associated with the fuel type, a data associated with a most recent change of price, a current margin, a graphical indicator of a proportion of total fuel sales at the associated site for the fuel type, a previous proposed price for the fuel type, competitor prices, rolling sales volume per product, percentage margin, a ratio of sales of products relative to other products, a predetermined number of previous prices, proportions of sales by a particular payment type such as cash or credit, a policy and a price trigger associated with review of the site.

Pricing page component 502 further provides a price adjustment interface 506 associated with each fuel type of the associated site. The price adjustment interfaces 506 allow a user to input price changes for one or more of the fuel types based upon information displayed in the pricing page, which can be configured to display all information that is relevant to the pricing and can be updated to display information for different sites with a single change in the search component 501. The user is therefore able to input price changes either using a pricing page component such as component 502 or using a map component such as map components 701, 406 and 603.

As shown in FIG. 6, pricing page component 602 graphically displays variation of prices associated with one or more fuel types. Pricing page component 602 may for example display variation with time of average price associated with each of a plurality of fuel types across the plurality of sites associated with search interface 601. Alternatively variation of price of a single fuel type at each of the plurality of sites or any other suitable data for graphical display may be displayed in a pricing page component.

It has been described above that pricing page components may be linked to search components such that a change made to the search component automatically affects the data displayed in the pricing page components. In some embodiments pricing page components may be linked to components other than search components, as will now be described.

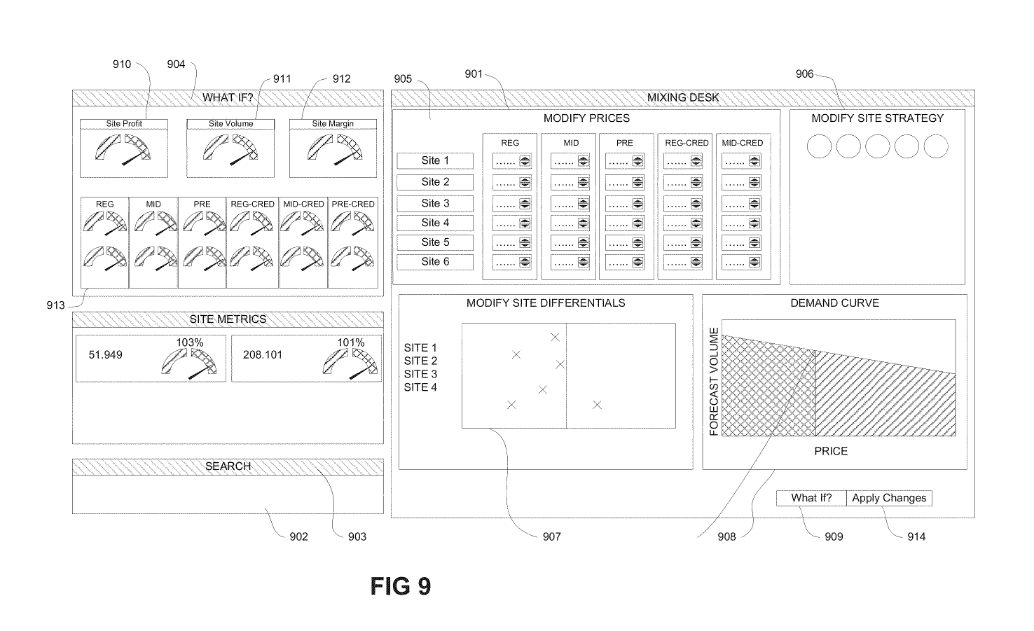

Referring first to FIG. 9, a scenario testing component 901 is shown. The scenario testing component is associated with a site 1235, for example by being linked to search component 902, and displays data associated with the site 1235. The search component 902 may be linked to further pricing page component such as component 903, which are arranged to display data associated with site 1235 such as data associated with current performance of the site relative to a plan. For example, component 903 shows performance of site 1235 relative to a current plan for site 1235 and performance of site 1235 relative to a previously implemented plan, together with data associated with fuel types of the site.

The scenario testing component 901 is further linked to a scenario effect component 904. The scenario testing component 901 comprises a plurality of user interface components 905, 906, 907, 908 that are initially populated with the current data associated with the site. The user interface components 905, 906, 907, 908 allow a user to input a proposed change to the current data and therefore allow a user to input a modification to the currently implemented plan for the associated site. Upon receipt of an indication from a user, the currently indicated values are processed using the modelling techniques described above to determine an estimate of the effect of user input modifications on the site.

The effect of the modifications is automatically displayed in the scenario effect component 904. The scenario effect component 904 includes a site profit variation indicator 910, site volume variation indicator 911 and site margin variation indicator 912. Each of the variation indicators 910, 911, 912 graphically illustrate whether the modification entered into the scenario testing component 901 have a positive or negative effect on the respective associated site property and may additionally provide a numerical indication of the effect. For example, as shown in scenario effect component 904, each of variation indicators 910, 911, 912 indicate a percentage change together with a value for the associate site property before and after the modifications. A further variation indicator 913 provides an indication of the effect on margin associated with each fuel type of the site.

The scenario testing component 901 and scenario effect component 904 provide a user with an indication of expected effect of modifications to current values at a site and allow the user to test various modifications. The modifications that may be tested using the scenario testing component may include price changes associated with one or more fuel types of the site, a change of policy, for example modification of a policy between one of maximising profit, maximising volume, and/or change of allowed price differentials relative to competitor sites. The modifications may be input in any convenient way. For example, user interface component 905 illustrates an interface for inputting price changes in which a text box is provided into which a user may enter amended prices, user interface component 906 illustrates a series of graphical buttons that each represent a respective one of a plurality of policies, user interface component 907 illustrates a graphical interface comprising markers for price differentials for each of a plurality of competitor sites and the markers may be dragged by a user to modify the price differentials and user interface component 908 illustrates a demand curve including a marker 913 that may be moved along the demand curve by a user to provide a modification to a target volume and/or to prices, with the effect of the modification on the other variable being illustrated on the demand curve. If the effect is desirable the modifications input to the scenario testing component may be automatically implemented by selection of a button 914.

As indicated above, the data illustrated in scenario effect component 904 is generated based upon the modelling described above. In particular, values input to scenario testing component 901 are processed according to (2) to generate an output site volume and according to (3) to generate an output site profit and margin can be generated based upon current costs and the generated volume and profit values. For example, input prices and input differentials are used as input values and as constraints respectively on (2) and (3).

In general terms an input policy is used to select a price of a range of possible prices generated by the modelling. For example, price data may be modelled according to the modelling described above and a range of possible prices for a retail fuel site is returned. The policy may then be used to select prices within the range of prices, for example with a maximum price in the range being selected where a policy of maximising margin is selected or a minimum price in the range being selected where a policy of maximising fuel sales is selected.

Alternatively, in some embodiments an input policy may also be used to determine constraints on (2) and (3). For example, where a policy is indicated as “maximise volume”, maximum volume constraints for the site are removed and lower constraints on prices may also be removed from the modelling. Conversely, where a policy is indicated as “maximise profit” all constraints may be removed such that an set of prices that optimise profit subject to no constraints on volume or prices is determined. The generated values are displayed in scenario effect component 904 as described above.

As described above, a change to search component 902 causes the site associated with scenario testing component 901 to be automatically changed based upon the search component and the data populated in the scenario testing component is automatically updated to current values for the site. When a user inputs modifications to the scenario testing component and the modelling is run on the new site the data in the scenario effect component 904 is automatically associated with the site associated with the search component 902.

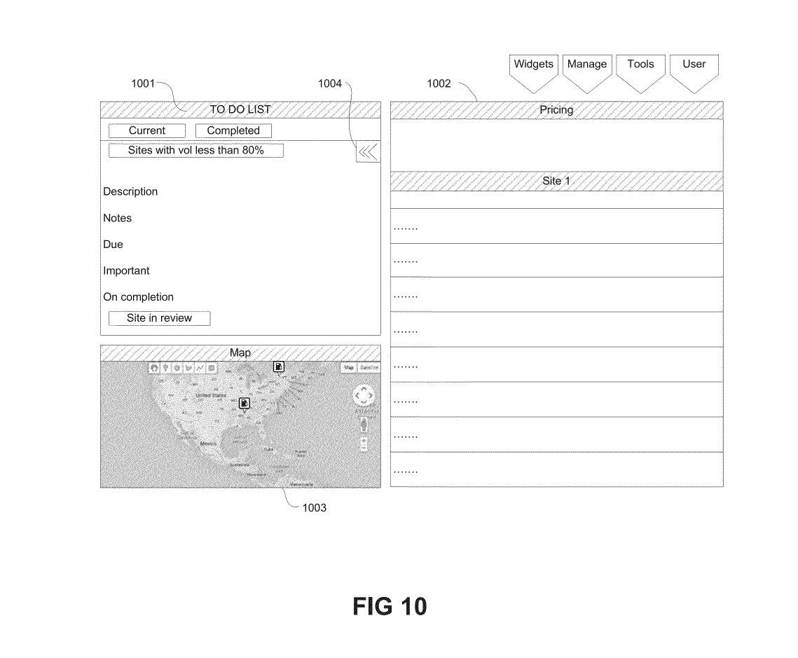

Referring to FIG. 10, a scheduled task component 1001 is shown. The scheduled task component 1001 provides an interface to tasks that are scheduled for the current user, each task being based upon a task criterion. For example, as shown in FIG. 10, scheduled task component 1001 indicates two currently outstanding tasks for the user.

A first scheduled task “Sites with vol less than 80%” is currently selected by the user and is shown in an expanded view and a second scheduled task “Site in review” is not currently selected and is shown in a reduced view. The expanded view provides the user with further information associated with the scheduled task including a description, any notes, when the task is due, whether the task is important and how the scheduled task should be treated when completed, for example repeated the following day or removed from the scheduled tasks.

As indicated above, each scheduled task is associated with a criterion. The criteria are stored at a server and processed at predetermined intervals, for example based upon a time associated with the scheduled task. Processing the scheduled tasks at the server comprises processing the stored data associated with the plurality of sites stored at the server based upon each of the criteria to determine sites that satisfy the criteria. For example, the criterion associated with the first scheduled task described above may comprise a database query that returns all sites associated with the user that are achieving a volume less than 80 percent of target volume.

When a new site satisfies a criterion associated with a user the site may be alerted to the user such that the user can set various criterion that are continually processed and alerted to the user when necessary. In this way the user is alerted of changes to sites that are relevant to the user when the change occurs without the user being required to search for the changes. The alert may be provided to the user in any convenient way, for example by way of a notification as part of the pricing page associated with the user or as part of the scheduled task component 1001 associated with the user.

Each scheduled task may have stored associated pricing page components that are associated with the task. Upon selection of a scheduled task the pricing page may be automatically configured based upon the pricing page components associated with the task, with each pricing page component being automatically linked to the currently selected task. For example, upon selection by a user of the first scheduled task described above, pricing page components 1002, 1003 may be automatically displayed to the user including data associated with the sites returned based upon the criterion associated with the first scheduled task. The displayed pricing page components may for example be input by the user and may comprise pricing page components that are useful for performing the scheduled task. Alternatively a button 1004 may be provided that allows the user to select pricing page components associated with the scheduled task that may be selected for display by the user. In this way, the user is provided with a customised display of information that assists with carrying out a task and the user experience is considerably improved.

Each component of the pricing page may be provided with a user selectable icon that when selected provides a help section associated with the component providing information specific to the component and/or the data displayed in the component. The information that is displayed to the user may for example include information associated with use of the associated component. Additionally the information that is displayed to the user may include information associated with the data that is displayed in the component. For example, the information may include general business information that may be useful for a user when considering information such as the information that is displayed in the component. Additionally or alternatively the information may include specific business information that is based upon the particular data that is displayed in the component.

For example, component 408 of FIG. 4 shows performance of a site against a current volume sales plan and against a previous volume sales plan. Upon selection of a button 412 by a user, general information associated with performance of a site against plans may be displayed such as questions that may be of assistance to a user when analysing data such as the data illustrating performance of the site against a volume sales plan. Additionally or alternatively information associated with a plurality of different volume sales plan performance values may stored and a lookup may be performed based upon the value for the volume sales plan performance of the site such that information that is displayed to the user comprises information that is relevant to the performance of the site for volume sales plan performance.

It will be appreciated that it is desirable for a user to be able to configure and store a pricing page associated with the user such that a plurality of user profiles are created and stored. Creation and selection of a user profile associated with a user may be carried out in any convenient way, for example as described in International Patent Publication Number WO2012/101415, which is hereby incorporated by reference.

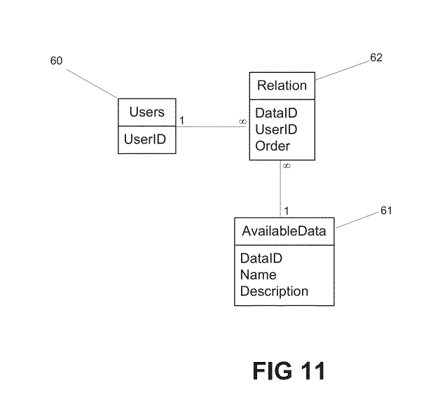

For example, FIG. 11 is an entity diagram of a database suitable for storing and managing data to be displayed as part of a pricing page for different users. As shown in FIG. 11, the database has three tables: a Users table 60; an AvailableData table 61 and a Relation table 62. Each entry of the Users table 60 is associated with a user of the system, each entry of the AvailableData table 61 is associated with a data item that may be displayed as part of a pricing page and each entry of the Relation table 62 indicates a relationship between a user and a data item, together with an order associated with display of the data item. It will of course be appreciated that the database also has tables associated with fuel price data for own site retail fuel sites and competitor retail fuel sites. The Users table 60 has a UsedID field which is its primary key, and may additionally have fields for storing data associated with each user such as a name field and a permissions field associated with data that the user is allowed to view and modify. The AvailableData table 61 has a dataID field which is its primary key, a Name field for storing the name of a data item and a Description field for storing a description of the data item. The Relation table 62 has a DataID field which identifies a record of the AvailableData table 61, a UserID field which identifies a record of the Users table 60 and an Order field which defines an order for display of the data item identified by the DataID field relative to other data items to be displayed.

When a pricing page is to be displayed for a particular user a lookup is carried out to identify all records of the Relation table 62 having a UsedID corresponding to the UsedID of the particular user. The DataID of each identified record identifies a record of the AvailableData table 61 which corresponds to a data item to be displayed as part of the pricing page which can then be displayed to the user.

The Users table 60 may additionally have fields for storing data associated with user specific data processing such as processing to automatically generate notifications for the user.

It will be appreciated that the entity diagram of FIG. 11 provides a portion of a larger database structure suitable for carrying out the invention. The database structure may be arranged in any suitable way known in the art.

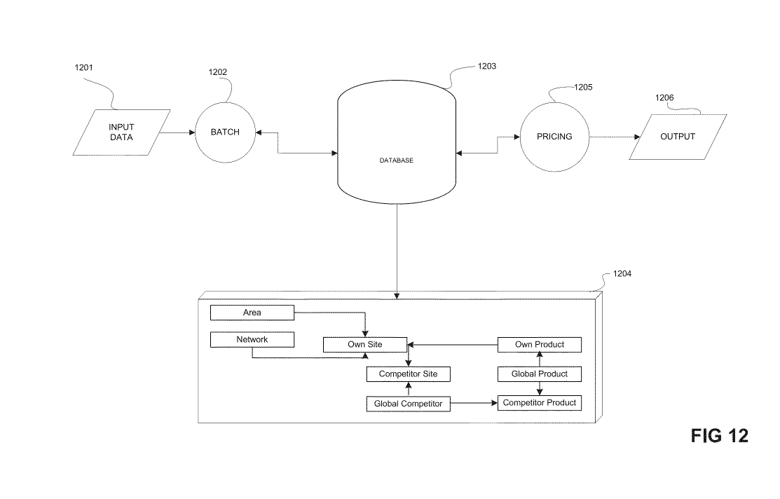

FIG. 12 is a schematic illustration of data flow in the pricing system described above. As shown in FIG. 12, input data 1201 is processed by batch processing 1202 at periodic intervals. The input data includes input competitor prices, own site price changes, changes to costs and sales data. The batch processing 1202 processes the input data 1201 based upon data stored in a database 1203 that stores data associated with pricing for retail fuel sites to determine whether the input data satisfies one of a plurality of predetermined criteria associated with one or more retail fuel sites.

The predetermined criteria are criteria that, if satisfied, require a new price to be generated for the one or more retail fuel sites associated with the criteria. For example, the predetermined criteria may include one or more checks on the input data 1201 to determine whether the input data 1201 includes a modification to a fuel price for a main competitor site stored in the database 1203 of an own site such that the modification requires prices to be generated for the own site. Alternatively or additionally the predetermined criteria may be associated with a change to costs for a fuel type associated with one or more own sites. Various other predetermined criteria will be apparent to one skilled in the art in light of the detail set out in the above description.

Schematic 1204 illustrates some of the data stored in the database 1203. In particular, as shown in schematic 1204, the database 1203 includes data associated with own sites, competitor sites, and products, and relationships therebetween.

Pricing processing 1205 is arranged to process the data stored in the database 1203 based upon the batch processing 1202 to generate output price recommendations 1206 for retail fuel sites, as described in detail above. For example, for each site identified by the batch processing 1202, fuel price data stored in the database 1204, including modifications received as part of the input data 1202, may be processed using the modelling described above with reference to equations (1) to (3). The pricing processing 1205 may additionally include user interactions with price recommendations that are automatically generated to determine final price recommendations for implementation at a retail fuel site. The user interactions may comprise interactions using the user interface components described herein.

In the above it has been described that a user may input price changes. The input price changes are processed based upon a property of the user that input the price changes. For example, different users may be provided with different permissions such that a price change input by a user with permissions to implement price changes may be automatically transmitted to a site for implementation, whereas a price change input by a different user may be transmitted to a further user for review before implementation. The permissions associated with a user may for example be based upon a stored user profile associated with the user and the user profile may be accessed by the user logging in to the pricing page upon initialisation of the pricing page, for example stored in the Users table 60 described above.

Although specific embodiments of the invention have been described above, it will be appreciated that various modifications can be made to the described embodiments without departing from the spirit and scope of the present invention. That is, the described embodiments are to be considered in all respects exemplary and non-limiting. In particular, where a particular form has been described for particular processing, it will be appreciated that such processing may be carried out in any suitable form arranged to provide suitable output data.

1-86. (canceled)

87. A computer-implemented method of displaying fuel price data, the method being implemented in a computer comprising a memory in communication with a processor, the method comprising:
receiving, as input to the processor, a plurality of fuel price data display components, each fuel price data display component being configured to display fuel price data;
receiving, as input to the processor, a search interface configured to receive input data indicating a search criterion associated with fuel price data;
receiving, as input to the processor, data indicating a link between the search interface and one or more of the plurality of fuel price data display components; and
displaying, on a display device coupled to the computer, said fuel price data, wherein said fuel price data is displayed in the one or more fuel price data display components linked to the search component based upon the search criterion.

88. A method according to claim 87, further comprising:
displaying, on said display device, said search interface; and
receiving, as input to the search interface, said search criterion.

89. A method according to claim 87, further comprising:
receiving, as input to the processor, a further search interface configured to receive further input data indicating a further search criterion associated with one or more retail fuel sites of the plurality of retail fuel sites;
receiving, as input to the processor, data indicating a link between the further search interface and one or more of the plurality of fuel price data display components; and
displaying, on the display device, said fuel price data, wherein said fuel price data is displayed in the one or more fuel price data display components linked to the further search component based upon the further search criterion.

90. A method according to claim 87, wherein displaying said fuel price data comprises, for each of said one or more fuel price data display components linked to the further search component, generating a graphical representation of said fuel price data associated with said fuel price data display component.

91. A method according to claim 87, wherein receiving data indicating a link between the search interface and one or more of the plurality of fuel price data display components comprises:
displaying, on the display device, said plurality of fuel price data display components;
displaying, on the display device, said search interface; and
receiving user input indicating a relationship between the search interface and one or more of the plurality of fuel price data display components.

92. A method according to claim 91, further comprising storing said received user input.

93. A method according to claim 87, further comprising processing said criterion to determine said fuel price data to be displayed.

94. A method according to claim 93, wherein displaying said fuel price data based upon the search criterion comprises:
selecting one or more retail fuel sites of a plurality of retail fuel sites based upon said criterion; and
displaying fuel price data associated with said selected one or more retail fuel sites.

95. A method according to claim 94, wherein said search criterion indicates a fuel price property, wherein selecting one or more retail fuel sites comprises:
for each of said one or more retail fuel sites, displaying fuel price data associated with the retail fuel site if the fuel price data associated with the retail fuel site satisfies the fuel price property.

96. A method according to claim 87, wherein said fuel price data comprises data associated with one or more retail fuel site properties selected from the group consisting of: fuel sales at one or more retail fuel sites; a fuel sales target at one or more retail fuel sites; a fuel price of one or more fuel types; a property of a retail fuel site; and one or more competitor sites associated with one or more retail fuel sites.

97. A system for displaying fuel price data, the system comprising:
a processor;
a display device coupled to the processor; and
a memory in communication with the processor, the memory storing computer readable instructions arranged to cause the processor to:
receive, as input to the processor, a plurality of fuel price data display components, each fuel price data display component being configured to display data fuel price data;
receive, as input to the processor, a search interface configured to receive input data indicating a search criterion associated with fuel price data;
receive, as input to the processor, data indicating a link between the search interface and one or more of the plurality of fuel price data display components; and
display, on the display device, said fuel price data, wherein said fuel price data is displayed in the one or more fuel price data display components linked to the search component based upon the search criterion.

98. A system according to claim 97, wherein the computer readable instructions are further arranged to cause the processor to:
display, on said display device, said search interface; and
receive, as input to the search interface, said search criterion.

99. A system according to claim 97, wherein the computer readable instructions are further arranged to cause the processor to:
receive, as input to the processor, a further search interface configured to receive further input data indicating a further search criterion associated with one or more retail fuel sites of the plurality of retail fuel sites;
receive, as input to the processor, data indicating a link between the further search interface and one or more of the plurality of fuel price data display components; and
display, on the display device, said fuel price data, wherein said fuel price data is displayed in the one or more fuel price data display components linked to the further search component based upon the further search criterion.

100. A system according to claim 97, wherein displaying said fuel price data comprises, for each of said one or more fuel price data display components linked to the further search component, generating a graphical representation of said fuel price data associated with said fuel price data display component.

101. A system according to claim 97, wherein receiving data indicating a link between the search interface and one or more of the plurality of fuel price data display components comprises:
displaying, on the display device, said plurality of fuel price data display components;
displaying, on the display device, said search interface; and
receiving user input indicating a relationship between the search interface and one or more of the plurality of fuel price data display components.

102. A system according to claim 101, wherein the computer readable instructions are further arranged to cause the processor to store said received user input.

103. A system according to claim 97, wherein the computer readable instructions are further arranged to cause the processor to process said criterion to determine said fuel price data to be displayed.

104. A system according to claim 103, wherein displaying said fuel price data based upon the search criterion comprises:
selecting one or more retail fuel sites of a plurality of retail fuel sites based upon said criterion; and
displaying fuel price data associated with said selected one or more retail fuel sites.

105. A system according to claim 104, wherein said search criterion indicates a fuel price property, wherein selecting one or more retail fuel sites comprises:
for each of said one or more retail fuel sites, displaying fuel price data associated with the retail fuel site if the fuel price data associated with the retail fuel site satisfies the fuel price property.

106. A system according to claim 97, wherein said fuel price data comprises data associated with one or more retail fuel site properties selected from the group consisting of:
fuel sales at one or more retail fuel sites; a fuel sales target at one or more retail fuel sites; a fuel price of one or more fuel types; a property of a retail fuel site; and one or more competitor sites associated with one or more retail fuel sites.

107. A computer readable medium carrying a computer program comprising computer readable instructions configured to cause a computer to carry out a method comprising:
receiving, as input to the processor, a plurality of fuel price data display components, each fuel price data display component being configured to display fuel price data;
receiving, as input to the processor, a search interface configured to receive input data indicating a search criterion associated with fuel price data;
receiving, as input to the processor, data indicating a link between the search interface and one or more of the plurality of fuel price data display components; and
displaying, on a display device coupled to the computer, said fuel price data, wherein said fuel price data is displayed in the one or more fuel price data display components linked to the search component based upon the search criterion.
